(19) United States
(12) Patent Application Publication
(10) Pub. No.: US 2007/0009074 A1
(43) Pub. Date: Jan. 11, 2007

(54) Timing recovery apparatus and method with frequency protection

(76) Inventor: Ching-Wen Ma, Nan Tou City (TW)

Correspondence Address: BIRCH STEWART KOLASCH & BIRCH, PO BOX 747, FALLS CHURCH, VA, 22040-0747, US

(21) Appl. No.: 11/481,851

(22) Filed: Jul. 7, 2006

(30) Foreign Application Priority Data
Jul. 7, 2005 (TW) 094122945

(51) Int. Cl. H04L 7/00

(52) U.S. Cl. 375/371

(57) ABSTRACT

A timing recovery apparatus and method with frequency protection are provided. The apparatus uses a frequency estimator to calculate and store an estimated frequency value as a pre-stored estimated frequency value when timing quality is good. A defect detector is used to determine whether a defective portion on a disk medium has been detected. When a defective portion has been detected, the pre-stored estimated frequency value is then used as the basis of phase lock and frequency lock to generate a reference clock. As the read operation performed over the defective portion is finished, the normal frequency lock mechanism is restarted. At this moment, the frequency lock mechanism can take less time to lock the input signal. Thus, the invention significantly reduces the missing readable data due to loss of frequency lock, and never breaks the normal tracking-frequency operation of the frequency lock mechanism.

This application claims the benefit of the filing date of Taiwan Application Ser. No. 094122945, filed on Jul. 7, 2005, the content of which is incorporated herein by reference.

### BACKGROUND OF THE INVENTION

1. Field of the invention

The invention relates generally to the field of timing recovery apparatus, and in particular to a timing recovery apparatus and method with frequency protection applied to an optical storage media reading system.

2. Description of the Related Art

Ordinarily, defects on optical storage media, such as CDs, digital video disks and high-definition digital video disks, consist of scratches, smears, fingerprints, incorrect recording and disks manufacturing problems. The defects may affect the frequency and the phase of the radio frequency signal, thereby resulting in frequency instability of the reference clocks generated by the timing recovery apparatus and the possibility of the missing readable data by a decoder of a CD player.

In 1993, Gardner (“Interpolation in Digital Modems—Part I: Fundamentals”, IEEE Trans. on Communications, vol. 41, no. 3, March 1993) discloses a timing recovery apparatus using a feedback loop to detect, track and lock the frequency and the phase of the input signal, thereby reading out the data. However, if there is a defect on a disk medium, the read-out frequency and phase of the input signal are damaged, which may result in the instability of the feedback loop and even completely wrong operations, such that the frequency lock mechanism may go into the out of lock state. Moreover, while a defect on the disk medium is detected, the frequency has already been drifted out to an incorrect frequency in the frequency lock mechanism, and it always takes time for the feedback loop to regain frequency lock. Consequently, some readable data is missing.

In U.S. Pat. No. 6,363,042, Sakashita teaches an optical disk drive provided with means for preventing an inner reference clock signal from being disordered when a defective portion is read. The optical disk drive is based on an analog phase-locked loop and uses a defect detection section to control the controllable switch to protect the frequency. As the drawback of the above-mentioned timing recovery apparatus, when the defect detection section detects a defect, the frequency may be drifted away. Further, the voltage hold circuit may take the risk of electric leakage. Both these two reasons result in the inaccuracy of frequency protection.

In US Publication No. US20030214331, Chang discloses the digital phase-locked loop device and the signal generating method. FIG. 1A is a block diagram of a conventional phase-locked loop device. FIG. 1B shows block diagrams of a conventional loop filter and a conventional lock controller. Referring to FIG. 1A and FIG. 1B, the digital phase-locked loop device 100 includes an interpolator 101, a timing error detector 102, a loop filter 103 and a lock detector 104. The interpolator 101 receives an input signal and then generates a synchronous sample signal. After receiving the synchronous sample signal, the timing error detector 102 generates a timing error value. Since the architectures and operations of the interpolator 101 and the timing error detector 102 are well known, the description is omitted here.

The loop filter 103 includes a phase register 1031, a frequency register 1032, two multipliers 1033, 1034, two adders 1035, 1037 and a multplexer 1036. After multiplying the timing error value by a first parameter K1, the multiplier 1033 stores the calculated result into the phase register 1031. The multiplier 1034 multiplies the timing error value by a second parameter K2. The adder 1035 adds the output value of the frequency register 1032 and the output value of the multiplier 1034. The multiplexer 1036 receives the output value of the adder 1035 and the backup value generated by the lock controller 104, and the selectively outputs either value to the frequency register 1032 according to the reread signal from the lock controller 104. The adder 1037 adds the output value of the phase register 1031 and the output value of the frequency register 1032 to generate the interpolator control value.

The lock controller 104 includes a lock detector 1041, a register 1042 and a multiplexer 1043. The lock detector 1041 enables the reread signal or the backup signal responsive to the timing quality of the synchronous sample signal. If the timing quality is poor, the lock detector 1041 enables the reread signal. Instead, the lock detector 1041 enables the backup signal while the timing quality turns great. The register 1042 stores the output value of the frequency resistor 1032 as the backup value. The multiplexer 1043 receives the output value of the frequency resistor 1032 and the backup value of the register 1042 and stores the output value of the frequency resistor 1032 into the register 1042 while the backup signal is enabled.

The drawback of the digital phase-locked loop device 100 is that the portion with poor timing quality where the lock detector 1041 has detected is not necessarily defective. For example, while data on a disk medium has been read, the lock detector 1041 may determine that the timing quality is bad even though there is no defective portion on the disk medium. And then, the frequency value stored in the register 1042 is inserted into the phase-locked loop. Consequently, it breaks the normal tracking-frequency operation of the phase-locked loop and establishes an unnecessary control over the loop. Moreover, when the phase-locked loop is influenced by external force or electricity, the frequency value stored in the register 1042 is also disordered. These problems cause instability and inefficiency to the phase-locked loop.

### SUMMARY OF THE INVENTION

In view of the above-mentioned problems, an object of the invention is to provide a timing recovery apparatus with frequency protection which is applied to an optical disk reading system, effectively improves the efficiency of the timing recovery of the system and avoids missing data by computing and protecting the average frequency after a defective portion on a disk medium has been read.

To achieve the above-mentioned object, the timing recovery apparatus with frequency protection of the invention, which is applied to an optical disk reading system, comprises an interpolator, a timing error detector, a defect detector, a loop filter and a frequency estimator.

Responsive to an input signal and an interpolator control value, the interpolator performs interpolation operation and then generates a synchronous sample signal. The timing error detector detects a timing error value for the synchronous sample signal. The defect detector determines whether a defective portion on a disk medium is detected to produce a detecting signal according to the envelope variations of the input signal, and then enables the detecting signal if a defective portion on the disk medium has been detected. The loop filter filters the timing error value to generate the interpolator control value and an estimated frequency value according to the detecting signal and a pre-stored estimated frequency value. The frequency estimator generates the pre-stored estimated frequency value according to the timing quality of the synchronous sample signal and the estimated frequency value. Wherein, the loop filter generates the interpolator control value responsive to the pre-stored estimated frequency value if the detecting signal generated by the defect detector is enabled.

Another object of the invention is to provide a timing recovery method with frequency protection, which is applied to an optical disk reading system, comprises the steps of interpolating an input signal, and then generating a synchronous sample signal responsive to an interpolator control value; determining whether a defect on a disk medium is detected according to the envelope variations of the input signal; detecting a timing error value for the synchronous sample signal; generating a pre-stored estimated frequency value according to the timing quality of the synchronous sample signal and an estimated frequency value; and generating the interpolator control value by adding a first phase value and the estimated frequency value if a normal region is read on the CD/DVD, or by adding the first phase value and the pre-stored estimated frequency value if a defect region is read on the CD/DVD.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1A is a block diagram of a conventional phase-locked loop.

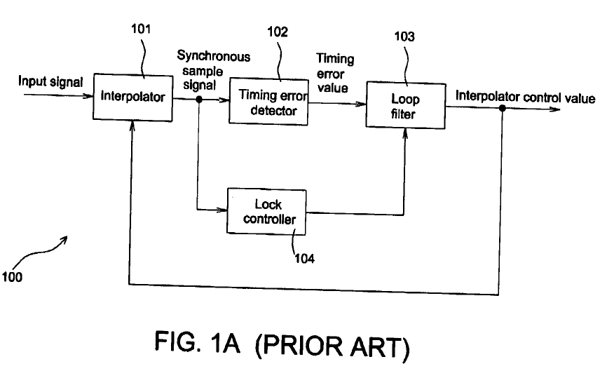

FIG. 1B are block diagrams of a conventional loop filter and a conventional lock controller.

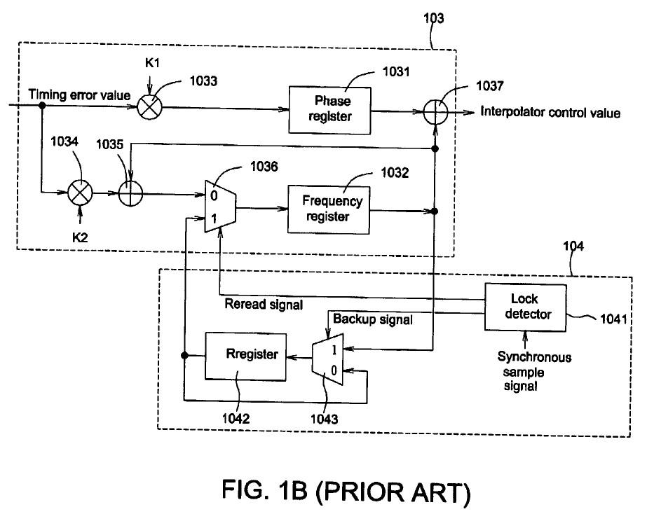

FIG. 2 is a block diagram of a timing recovery apparatus with frequency protection according to the invention.

FIG. 3 is a detailed block diagram of the loop filter and the frequency estimator in FIG. 2.

FIG. 4 is a flow chart illustrating the timing recovery method with frequency protection according to the invention.

FIG. 5 is a flow chart illustrating the step of generating a pre-stored frequency value in FIG. 4.

### DETAILED DESCRIPTION OF THE INVENTION

The timing recovery apparatus and method with frequency protection of the invention will be described with reference to the accompanying drawings.

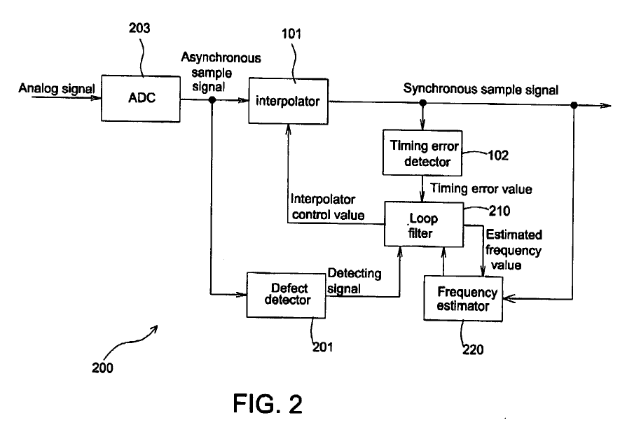

FIG. 2 is a block diagram of a timing recovery apparatus with frequency protection according to the present invention. The timing recovery apparatus 200 with frequency protection is applied to an optical disk reading system and comprises an interpolator 101, a timing error detector 102, a defect detector 201, a loop filter 210 and a frequency estimator 220.

After having received an asynchronous sample signal and an interpolator control value, the interpolator 101 performs interpolation operation and then generates a synchronous sample signal. The timing error detector 102 detects a timing error value for the synchronous sample signal. The defect detector 201 determines whether a defective portion on the optical disk medium is detected in order to produce a detecting signal according to the envelope variations of the asynchronous sample signal, and simultaneously enables the detecting signal if a defective portion on the optical disk medium has been detected. The loop filter 210 filters the timing error value to generate the interpolator control value and an estimated frequency value according to the detecting signal and a pre-stored estimated frequency value. The frequency estimator 220 generates the pre-stored estimated frequency value according to the timing quality of the synchronous sample signal and the estimated frequency value.

Wherein, the loop filter 210 generates the interpolator control value responsive to the pre-stored estimated frequency value while the detecting signal generated by the defect detector 201 is enabled.

Because the envelope amplitude of the synchronous sample signal, corresponding to the defective portion, is much smaller than that of the synchronous sample signal, corresponding to a portion other than the defective portion, the defect detector 201 uses the envelope variations of the asynchronous sample signal to determine whether a defective portion on the optical disk has been read. In addition, the asynchronous sample signal is generated by an analog-to-digital converter (ADC) 203 after an analog signal has been sampled.

Because the linear velocity is almost kept constant during the reading operation of the CD/DVD player for the defective portion on the disk medium, the frequency may be considered as constant. In advance, the invention computes a correct estimated frequency value, then protects and stores the estimated frequency value as the pre-stored estimated frequency value by using the frequency estimator 220 while the normal portion on the disk medium is read. When a defective portion is read, the frequency estimator 220 makes phase lock and frequency lock according to the pre-stored estimated frequency value. As the reading operation for the defective portion is finished, the frequency estimator 220 immediately lock the synchronous sample signal such that the optical disk reading system reads data correctly and efficiently, thereby avoiding missing readable data. Further, the estimated frequency value computed by the frequency estimator 220 is not disordered by noise since the frequency is almost constant.

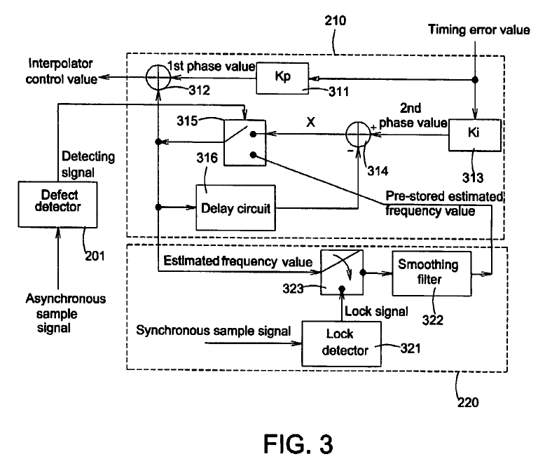

FIG. 3 is a detailed block diagram of the loop filter and the frequency estimator in FIG. 2. Referring now to FIG. 3, the frequency estimator 220 comprises a first switch 323, a lock detector 321 and a smoothing filter 322.

According to the invention, if the absolute value ratio of two adjacent synchronous sample signals located at two sides of a zero cross point is close to 1, the timing quality is in a good state. Adversely, the timing quality is in the bad state when the absolute value ratio is far away from 1. Therefore, the lock detector 321 generates a lock signal by comparing the absolute value ratio of two adjacent synchronous sample signals located at two sides of a zero cross point with a threshold value. The first switch 323 is turned on or off the switch according to the lock signal.

If the quality of the interpolated synchronous sample signal is good, the timing quality of the loop is good as well and the frequency is almost correct. At this time, if the signal is passed through the smoothing filter 322, a reliable estimated frequency value will be obtained. Therefore, when the lock signal indicated that the timing quality is good, the first switch 323 is turned on. Meanwhile, the smoothing filter 322 performs frequency estimation for the estimated frequency value, outputs and stores the estimated frequency value as the pre-stored estimated frequency value. Contrarily, when the lock signal indicated that the timing quality is bad, the first switch 323 is turned off and the smoothing filter 322 directly outputs the pre-stored frequency estimated value as the estimated frequency value. It should be noted that the estimation method used in the smoothing filter 322 doesn't result in the variations of the pre-stored estimated frequency value due to the short-term variations of the estimated frequency value. Thus, losing lock suddenly caused by reading the defective portion will not affect the output of the smoothing filter 322.

With reference to FIG. 3, the loop filter 210 comprises a first multiplier 311, a second multiplier 313, an adder 312, a subtractor 314, a delay circuit 316 and a second switch 315.

The relation between the phase and the frequency is as follows:
θ=2πft0dθ/dt=2πf

Hence, the subtractor 314 performs subtraction operation over two successive phase values and then generates a frequency value.

After multiplying the timing error value output from the timing error detector 102 by a first gain value Kp, the first multiplier 311 generates a first phase value. The second multiplier 313 multiplies the timing error value by a second gain value K1, and then generates a second phase value. The delay circuit 316 delays the estimated frequency value for a predetermined time to produce a frequency estimation delay value (not shown). The subtractor 314 subtracts the frequency estimation delay value from the second phase value to generate data X. The second switch 315 is controlled by the detecting signal. In other words, if the detecting signal indicated that there is no defect on the disk medium, the output terminal of the second switch 315 is connected to the output terminal of the subtractor 314, i.e. data X is output as the estimated frequency value. Instead, if the detecting signal indicated that there is a defect on the disk medium, the output terminal of the second switch 315 is connected to the output terminal of the frequency estimator 220, i.e. the pre-stored estimated frequency value is output as the estimated frequency value. The adder 312 adds the first phase value and the estimated frequency value to generate the interpolator control value.

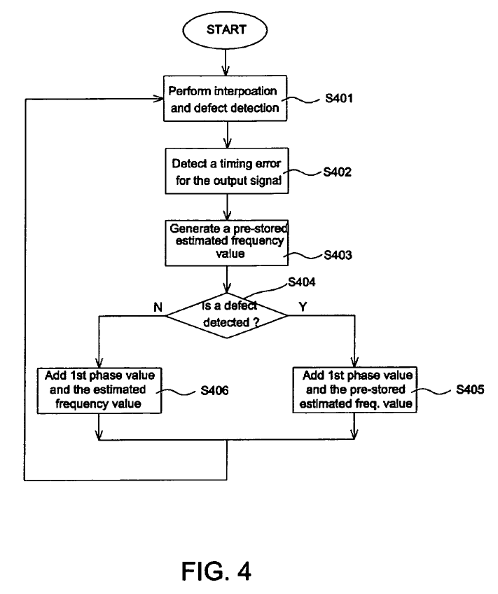

FIG. 4 is a flow chart illustrating the timing recovery method with frequency protection according to the invention.

Step S401, responsive to an interpolator control signal, an input signal is interpolated to generate an output signal. Meanwhile, it is determined whether a defective portion on a disk medium has been detected in accordance with the envelope variations of the input signal.

Step S402, a timing error value for the output signal is detected.

Step S403, a pre-stored estimated frequency value is generated according to the timing quality of the output signal and an estimated frequency value.

Step S404, it is determined whether a defective portion on a disk medium has been detected. When there is a defect on the disk medium, then jump to step S405, otherwise jump to step S406.

Step S405, the first phase value and a pre-stored estimated frequency value are added together to obtain the interpolator control value.

Step S406, a first phase value and an estimated frequency value are added together to obtain the interpolator control value.

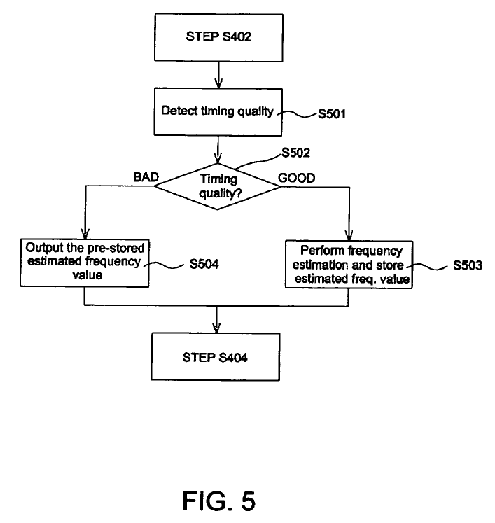

FIG. 5 is a flow chart illustrating the step of generating a pre-stored estimated frequency value in FIG. 4. The step of generating a pre-stored estimated frequency value step in accordance with FIG. 5 is detailed hereinafter.

Step S501, the timing quality of the output signal is detected, which is mainly in accordance with the result by comparing the absolute value ratio of two adjacent output signals located at two sides of a zero cross point with a threshold value.

Step S502, the timing quality of the output signal is determined. If the timing quality is good, then jump to step S503, otherwise jump to step S504.

Step S503, the frequency estimation operation is performed for the estimated frequency value, and then the estimated frequency value is output and stored as a pre-stored estimated frequency value.

Step S504, the stored data is directly output as the pre-stored estimated frequency value.

Wherein, the input signal is an asynchronous sample signal and the output signal is a synchronous sample signal.

In summary, this invention uses the frequency estimator 220 to compute and store the estimated frequency value as the pre-stored estimated frequency value if the timing quality is good. This invention also determines whether a defective portion on the disk medium is read according to the output of the defect detector 201. If a defective portion on the disk medium has been read, the pre-stored estimated frequency value is then used as the basis of gaining phase lock and frequency lock of the circuit to read out the data in the defective portion. As the read operation performed over the defective portion is finished, the frequency is unlocked and the normal frequency lock mechanism is restarted. At this moment, the frequency estimator 220 instantly relocks the synchronous sample signal. Therefore, the invention significantly reduces the missing readable data due to loss of frequency lock, and never breaks the normal tracking-frequency operation of the phase-locked loop, thereby solving the problems of prior art simply and efficiently.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A timing recovery apparatus with frequency protection, applied to an optical disk reading system, comprising:
an interpolator for performing interpolation operation, receiving an input signal and an interpolator control value, and generating a synchronous sample signal;
a timing error detector for detecting a timing error value for the synchronous sample signal;
a defect detector for determining whether a defective portion on a disk medium is detected according to the envelope variations of the input signal and generating a detecting signal, which is enabled when the defective portion is detected;
a loop filter for filtering the timing error value to generate the interpolator control value and generating an estimated frequency value according to the detecting signal and a pre-stored estimated frequency value; and
a frequency estimator for generating the pre-stored estimated frequency value according to the timing quality of the synchronous sample signal and the estimated frequency value;
wherein the loop filter generates the interpolator control value responsive to the pre-stored estimated frequency value when the detecting signal is enabled.

2. The timing recovery apparatus as claimed in claim 1, wherein the frequency estimator comprises:
a first switch for receiving the estimated frequency value;
a lock detector for generating a lock signal to control the first switch in accordance with the result by comparing the absolute value ratio of two adjacent synchronous sample signals located at two sides of a zero cross point with a threshold value; and
a smoothing filter that performs the frequency estimation operation for the output signal from the first switch while the first switch is turned on, and that directly outputs the pre-stored estimated frequency value while the first switch is turned off.

3. The timing recovery apparatus as claimed in claim 1, wherein the loop filter comprises:
a first multiplier for multiplying the timing error value by a first gain value to generate a first phase value;
a second multiplier for multiplying the timing error value by a second gain value to generate a second phase value;
a delay circuit that delays the estimated frequency value for a predetermined time to produce a frequency estimation delay value;
a subtractor for subtracting the frequency estimation delay value from the second phase value;
a second switch controlled by the detecting signal and outputs the output signal of the subtractor as the estimated frequency value when the detecting signal is disabled, or outputs the pre-stored estimated frequency value as the estimated frequency value when the detecting signal is enabled; and
an adder for adding the first phase value and the estimated frequency value to generate the interpolator control value.

4. The timing recovery apparatus as claimed in claim 1, wherein the input signal is generated by an analog to digital converter.

5. The timing recovery apparatus as claimed in claim 4, wherein the analog to digital converter samples an analog signal in order to generate the input signal.

6. The timing recovery apparatus as claimed in claim 1, wherein the input signal is an asynchronous sample signal.

7. A timing recovery method with frequency protection, applied to an optical disk reading system, comprising the steps of:
interpolating an input signal and then generating a synchronous sample signal responsive to an interpolator control value;
determining whether a defective portion on an optical disk medium is detected according to the envelope variations of the input signal;
detecting a timing error value for the synchronous sample signal;
generating a pre-stored estimated frequency value according to the timing error value of the synchronous sample signal and a estimated frequency value; and
generating the interpolator control value by adding a first phase value and the estimated frequency value when a normal portion on a disk medium is detected, or by adding the first phase value and the pre-stored estimated frequency value when a defective portion on the disk medium is detected.

8. The timing recovery method as claimed in claim 7, wherein the step of generating a pre-stored estimated frequency value comprises the steps of:
detecting the timing quality for the synchronous sample signal; and
performing the frequency estimation for the estimated frequency value, then outputting and storing the estimated frequency value as the pre-stored estimated frequency value if the timing quality of the synchronous sample signal is good, or outputting the stored estimated frequency value directly as the pre-stored estimated frequency value if the timing quality is bad.

9. The timing recovery method as claimed in claim 8, wherein the step of detecting the timing quality comprises the step of comparing the absolute value ratio of two adjacent synchronous sample signals located at two sides of a zero cross point with a threshold value.

10. The timing recovery method as claimed in claim 7, wherein the input signal is generated by sampling an analog signal.

11. The timing recovery method as claimed in claim 7, wherein the input signal is an asynchronous sample signal.
